(19) United States
(12) Patent Application Publication
(10) Pub. No.: US 2015/0039496 A1
(43) Pub. Date: Feb. 5, 2015

(54) DIGITAL CURRENCY DISTRIBUTION SYSTEM WITH ACOUSTIC TRIGGERS

(71) Applicant: ACTV8, Inc., Beverly HIlls, CA (US)

(72) Inventor: Brian Shuster, Los Angeles, CA (US)

(21) Appl. No.: 14/449,054

(22) Filed: Jul. 31, 2014

Related U.S. Application Data
(60) Provisional application No. 61/860,738, filed on Jul. 31, 2013.

(51) Int. Cl. G06Q 20/06

(52) U.S. Cl. CPC G06Q 20/065
USPC 705/39

(57) ABSTRACT

A system and method are disclosed to determine an action to be taken for currency delivery to a client. The method provides for the triggering and delivery of digital currency from television sets and audio devices to mobile devices by way of acoustic triggers, which are inaudible and/or indiscernible to the human ear. The acoustic triggers use a method of encoding an identifying data sequence into digital information, convert the digital information into analog audio pattern, transmit the pattern with loud speakers, receive the audio pattern with a microphone, convert the analog audio pattern into digital information, decode the digital information back to an identifying data sequence. The identifying sequence is then authenticate and validated with a server which associates the sequence with currency that can be redeemed at retail point-of-sale terminals or online and used to purchase goods and services. The different frequency sets that are present in these inaudible tones can be assigned monetary values that can be transferred between any two devices so long as the emitting device has a speaker and the receiving device has a microphone.

### BACKGROUND OF THE INVENTION

The invention enables the transfer of digital currency utilizing acoustic or low energy Bluetooth triggers.

Currency can be transferred from any device with a speaker (TV sets, radios, retail sound systems, digital signage, smartphones, tablets, computers, etc.) to any device with a microphone (smartphones, tablets, computers, etc.). The currency that can be transferred, utilizing acoustic or BluetoothLE triggers includes: cash, credit, and various forms of coupons.

The invention relates to the fields of server/client pattern and data transmission, with acoustic or low energy Bluetooth beacons used as a triggering and transport medium. The client is defined as an individual with a computing device that has a microphone and is capable of communicating with a server and decoding the acoustic or BluetoothLE data and converting those triggers to specific monetary value and then facilitating the movement of the funds.

The acoustic pattern is created via a proprietary protocol that maps a sequence of frequencies to digital data. The digital data is then encoded with an error detection/correction algorithm that validates all recorded acoustic patterns. This system allows for the tracking of the currency throughout its lifecycle, from creation to redemption, including the number of clients that received the data and converted it to a digital currency and the redemption of the currency. With BluetoothLE beacons, the beacon identifier can be attached to an offer and that offer can represent the transfer of a specific amount of value (currency); the BluetoothLE data is decoded by the server and triggers an associated amount of currency from a designated account to a designated second account.

This patent does not rely on any specific frequency audio spectrum. Frequencies can be assigned on an application-by-application basis. In today's marketplace, this patent functions across the majority of microphones and speakers and needs no additional hardware.

### SUMMARY OF THE INVENTION

It is the goal of the invention to provide a means to trigger the transmission of currency to a client watching TV, listening to radio (or any device with a speaker), or within range of Bluetooth beacons or digital signage in retail environments. The transfer uses acoustic sound or BluetoothLE, and facilitates the redemption of such currency in both the brick-and-mortar and online environments. The lifecycle of the currency is completed upon redemption. The invention will provide a system that manages currency association with a digital ID at which point the system will synchronize with a point-of-sale (POS) network (both online and brick-and-mortar) to validate the currency. The digital ID is then encoded into a transmissible data format that will be henceforth referred to as “digital payload.”

The transmission process is as follows:

1. The digital payload is converted into an analog wave pattern that can be played over a speaker.

2. The sound wave carrying the payload is then recorded by a microphone on a client's device.

3. The sound wave is digitized and converted back into a digital payload.

4. The digital payload is then decoded back to the digital ID.

5. The digital ID is exchanged into the currency once validated.

With the currency, the client can apply discountable value towards the purchase of products at a POS system via any transaction technology available to the client's device.

The data can be transmitted to the client's device, in an acoustic range that can be detected and recorded by a client's microphone equipped computing device.

This ecosystem leverages a centralized server that interfaces with advertisers, POS networks, broadcasters and clients/consumers. This system allows advertisers to create currencies and apply rules such as: limits on the number of consumers who can exchange the digital ID for currency, limits on the exchange period, limits on the value of the currency, and limits on locations where the currency can be redeemed.

As the server interacts with POS networks, this system will synchronize the newly created currencies with the POS, so they can be recognized by the POS client(s). In regards to the broadcaster (TV broadcast via TV speakers, retail environment via digital signage, etc.), the server will encode the digital ID associated with the currency into a medium (audio file, BluetoothLE data, etc.) that the broadcaster will transmit to the client.

The server will then validate the data captured by the client against the advertiser rules, and return a digital currency that the client can redeem at a POS client.

### BRIEF DESCRIPTION OF THE DRAWINGS (ATTACHED)

FIG. 1 is a flow chart showing the whole system.

FIG. 2 is as block diagram showing the detail of the encoding/decoding process.

FIG. 3 shows an acoustic to alphanumeric value conversion example.

### DETAILED DESCRIPTION OF THE INVENTION

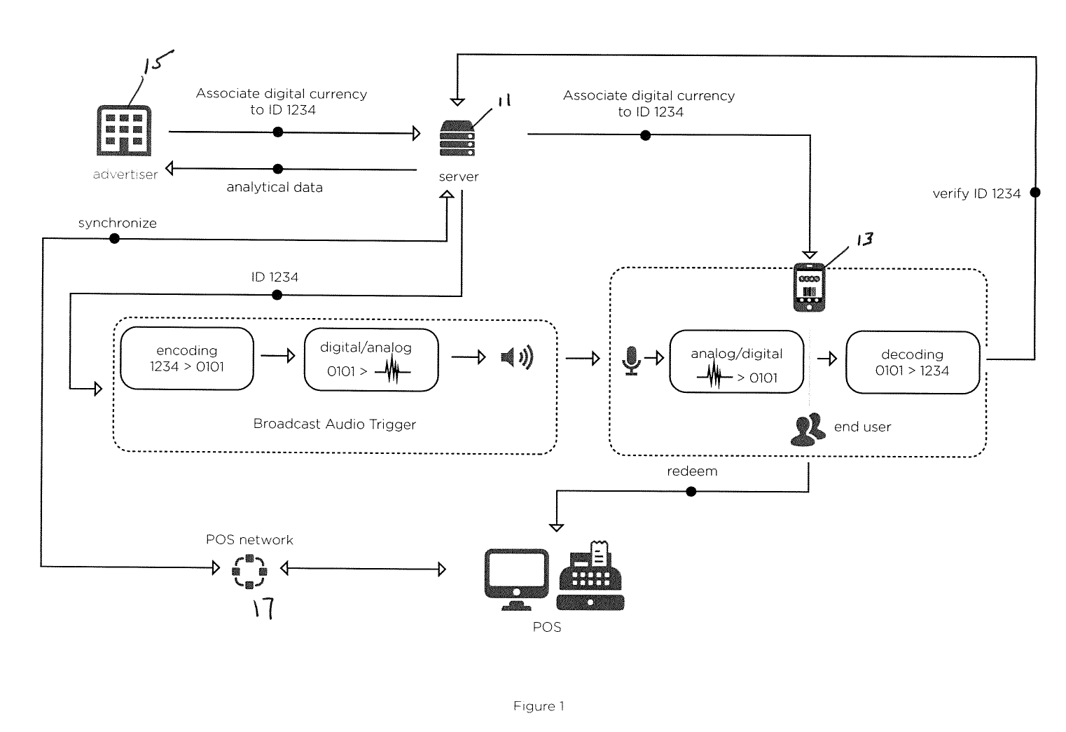

The system as described in FIG. 1 will allow the advertiser to create a currency from the server and synchronize it with the POS network. Both the server and the POS network are cloud-based service providers.

The server provides a set of services that allow for the creation of currency and rules for the currency. The rules are translated to the POS network and associated with a unique identifier upon creation. The unique identifier is encoded into the media of choice for transmission purposes.

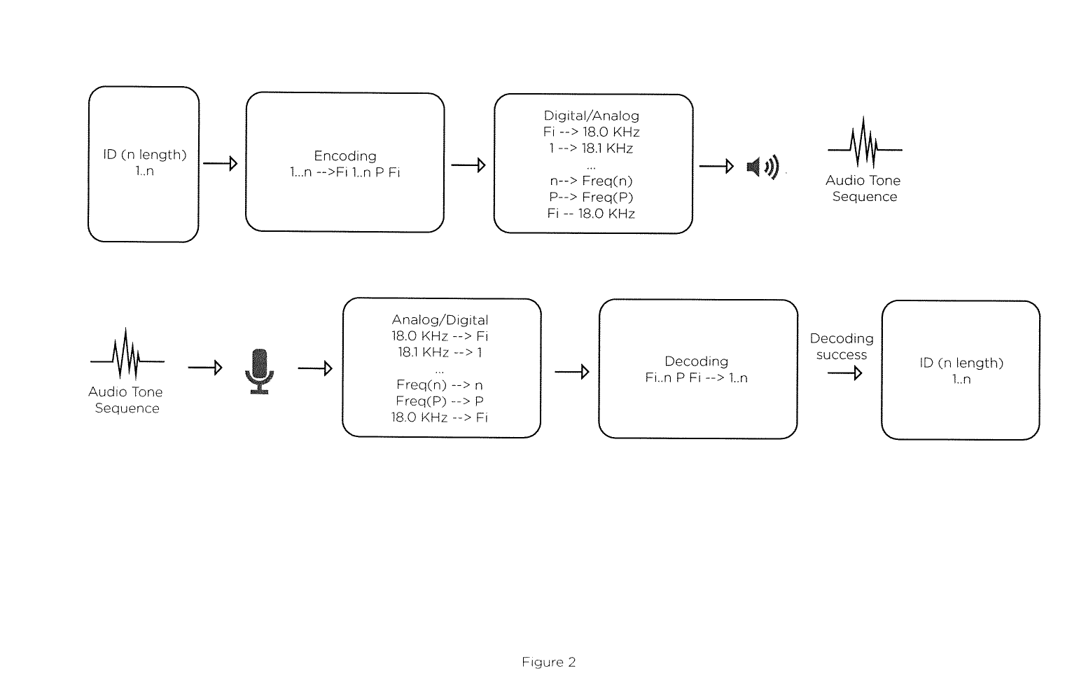

FIG. 2 displays an example of the encoding process for the acoustic transport medium. The process is broken down into components including encoding, digital to analog conversion, broadcast, recording, analog to digital conversion, and decoding.

The unique identifier is encoded into a sequence of data that includes a CRC (Cycle Redundancy Check). For example, 1234 will be encoded into an alphanumeric string comprised of ‘F0’12340‘F0’ where ‘F0’ is a sequence identifier for the protocol. 1234 is the direct transcription of the unique identifier when ‘0’ is the CRC check digit generated with the sequence 1234.

Once the encoding sequence is complete, the alphanumeric string is converted into an analog sequence of audio frequencies. This is done by mapping each element to a predetermined frequency. For example, the sequence ‘F0’ can be marked as frequency 18 kHz when digital data (0 to 9) can be allocated from 18.15 kHz to 20 kHz. The CRC check digit is also represented as digital data.

Since this protocol depends on a sequence of frequencies, two identical digits in a sequence will provide the same frequency. To avoid ambiguity, two formats are currently in use to resolve this issue:

### Format 1:

A tone-set can is defined with 21 tones to represent 21 values: 0-9, F0-F9 and NOP. 0-9 represent numeric digits, F0-F9 defines ten “function values” used to define the use of the audio barcode, and finally, “NOP” is a tone with no value used to separate duplicate digits.

For example, 1122 would be transcribed as <F0>1<NOP>1 2<NOP>2 8<F0>, so that, “1122” can be represented by 9 tones. (The second-to-the-last tone “8” is the CRC check digit).

### Format 2:

A tone-set can is defined with 28 tones to represent 28 values: 0-9, F0-F9 and Repeat-Previous-Value-N-times R1 (repeat previous value once), R2 (Repeat previous value twice), R3 (repeat previous value 3 times) . . . R8 (Repeat Previous Value 8 times).

For example, 1122 would be transcribed as <F0>1<R1>2<R1>8<F0>, so that, “1122” can be represented by 7 tones. (The second-to-the-last tone “8” is the CRC check digit).

This second method has the advantage that every tone has one or more values and repeating digits shorten the audio barcode instead of lengthening it.

### EXAMPLE

Worse case scenario: represent a value like “55555555” with the function value of 1 (F1) and the CRC check digit of “0”.

Format 1: “5555555” would encode as “<F1>5<NOP>5<NOP>5<NOP>5<NOP>5 <NOP>5<NOP>5<NOP>5 8 <F1>” (18 tones—about 1.8 seconds).

Format 2: “5555555” would encode as “<F1>5<R7>8<F1>” (5 tones—about 0.5 seconds).

The duration of each tone is determined by this protocol. In general, it should be of the same or greater value than the reader audio FFT duration; i.e., if a sequence of n digits is encoded from tones of 100 ms each, the sequence would be n*100 ms long. FFT stands for Fast Fourier Transform and is a well-known process used to convert digitalized audio wave signal form into frequency intensity maps.

The sequence is played over a speaker and recorded on a device with a microphone. The digitization of the audio is a well-known process involving sample rate, bits, number of channel (mono/stereo) and FFT size. The tone period from the sender should be bigger than the FFT size. In this case, we have the sender's tone size at 100 ms, which means that the reader/receiver FFT size should be 100 ms or less. With a ratio between 1:3 to 2:3 between the sender and receiver, we can achieve satisfactory results; keeping the sequence short helps to prevent audio interference.

Because the receiver is filtering frequencies in order to only check the known frequencies related to the protocol, it will allow the signal to be played in noisy environments and alongside broadcast video or other common audio content.

The server is a service provider 11 that can be accessed by the client's device 13. Clients are tracked and logged in the server. When a currency is requested with a digital ID from a client, the server is checking the information against an advertiser's 15 set of rules and the client's profile to either deliver the correct content or deny the request.

In case a client is qualified to exchange the digital ID for a digital currency, the server would duplicate the currency and register it with the POS network 17. A unique identifier from the POS network is associated with the digital currency that is returned to the client and stored in an online locker host on the server.

At redemption, the client 13 will use this currency registered with the POS network 17 to redeem for goods. Upon redemption, the POS network will update the server 11 regarding the transaction, which will modify the client's online locker. Advertisers 15 can then get analytical data from the point of creation of their currency all the way though to the redemption. This tracking system may use any information available such as GPS, time, or demographic information. This system can then provide the advertisers with information that has never before been available at this scale.

### Acoustic Triggered Currency/Content Targeting

The technology includes expanded functionality that allows the client to manually select currency towards the goods and services they would like to receive. For example, a client could express interest in technology, dining, and clothing via a displayed opt-in list. This functionality ensures that the client has total control of the overall interaction limits and the currency/content delivered via each interaction. When selected, this data is sent to the remote server when the client requests the digital currency. This data is used in the data query and profile generation to ensure the client receives the specific currency based on the client's specified profile.

The described acoustic triggering technology requires the following technology to provide the described experience to the client:
A mobile device such as a smartphone or tablet (e.g. iPhone, iPad Tablet, Android Phone/Tablet, Windows Phone/Tablet, etc.).
The device must have an integrated microphone.
The device must have a compatible acoustic trigger translation application as described below.
The contextual information provider needs to provide an audio source at the endpoint of acoustic trigger use—this can be as simple as a speaker with a playback device containing one or more predefined acoustic triggers or something much more advanced such as a networked system of out-of-home displays.

Each associated acoustic trigger translation application is designed to provide at least the minimal functionality required to detect and decode an Ultrasound trigger and process it as described below.

### Basic Functionality and Processing of Acoustic Triggers

When a valid acoustic trigger is detected, the application layer listens to and interprets the detected tones the trigger is comprised of. The associated application then translates the detected trigger into an alphanumeric value. After the tone to alphanumeric translation has occurred and been validated, the alphanumeric string is then transmitted to an external web based database. From here the associated currency/content is identified based on the transmitted alphanumeric value and delivered back to the client's device that contains the associated application. The digital currency and its associated value are predetermined by the brand offering the currency to consumers. The currency type, amount, and what good or service that it applies to is manually created and entered into the external database and associated with a specific alphanumeric string.

When the server completes the currency/content transaction with the client, the value of the currency associated with the trigger is determined/assigned and a debit is made from a holding account (for a specific vendor or general account) and credited to the account holder (client) account. For example, the vendor provides information detailing how many promotions/pieces of digital currency a specific campaign should have. If, for example, the number is 100, when the client account receives the digital currency, the available pool is now reduced to 99. Thus, the offering vendors stock of currency is reduced as each client captures and stores the digital currency.

### Acoustic Trigger Logic

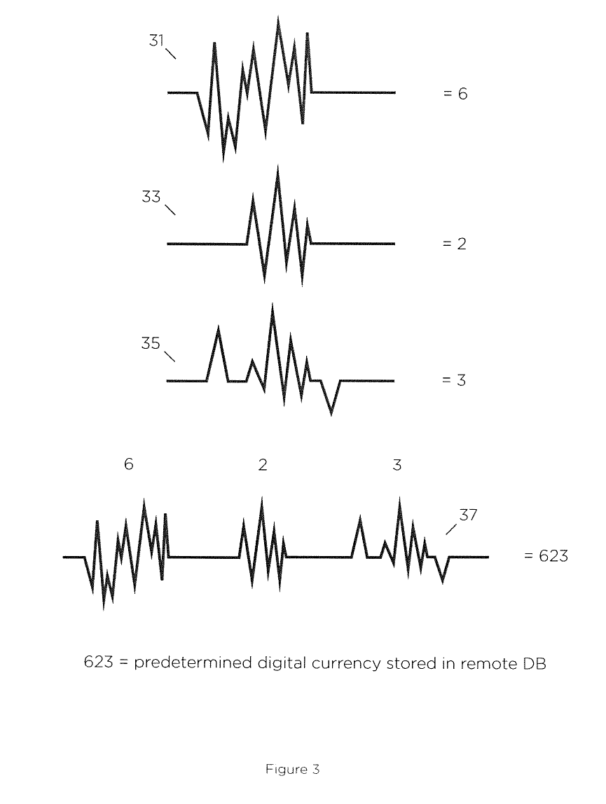

When the application layer detects a valid acoustic trigger it performs an analysis and breaks down the trigger into frequency segments. The analysis takes into consideration the actual frequencies used, the duration of each and the sequence, and the amplitude; this allows multiple frequencies to be layered together to form multi-tone frequencies. For example, as shown in FIG. 3, each frequency/tone/pattern is equal to an alpha or numeric value. Combining these tone combinations allows for the creation of multi-tone values. As shown, in FIG. 3, the frequency segment 31 represents the number 6, frequency segment 33 represents the number 2 and frequency segment 35 represents the number 3. When the three segments are transmitting in sequence with a short space with no Ultrasound signal between, the result is the frequency segments 37 which would decode as the number 623. The specifics of how to decode the frequency segments depend on the specific encoding technique employed, both of which are well known in the art.

### Example Usage in Marketplace

In one use case, an application can integrate the acoustic trigger technology to enable automated requests for digital currency transactions on behalf of select brands and merchants. When the client launches the application and selects automated mode, the device will automatically listen for a valid trigger. Once detected, the application will convert the detected trigger into an alphanumeric string that represents a stored digital currency value on a remote server, a brand/vendor account, and a type (a discountable value or a redeemable cash value for use in a purchase with the vendor/brand). The mobile device sends the alphanumeric string to the server, which queries the requested currency/content and responds to the client's device with the appropriate associated currency/content.

In another use case, the client sets their receiving device to active listening mode. This setting allows the device to listen for acoustic triggers on a singular instance basis. When a valid trigger is detected, the application screen will alert the client to the identification of a valid acoustic trigger detection. The mobile device would then request the appropriate currency/content from the remote server.

If the client chooses to save and redeem the currency/content at a retailer (in store or online), the server then carries out the final digital currency transaction. This involves debiting the client's account the discountable or monetary value, and crediting the retailer's account with the same amount. This amount is then instantly applied to the client's remaining transaction balance.

### Technology Use Case

There are many applications where getting contextual information and/or services to a person's mobile device is desirable and welcome. One such example is use with television programming. Incorporation of acoustic triggers into standard television programming and advertising broadcasts allows for the delivery of expanded content to the client. For example, a client is watching a television show that cuts to a commercial break. During this commercial break, a commercial is aired that includes an embedded acoustic trigger. The client's mobile device which is running the above-described application, would then detect the acoustic trigger embedded in the advertisement, translate it into an alphanumeric value and transmit it to a remote server. The remote server would then identify the client and the currency type/amount associated with the alphanumeric value. Once identification has been completed, a piece of digital currency they could redeem in a store or online for a discount off of a purchase of the product which was the subject of the commercial would be delivered directly to the client's mobile device for subsequent redemption.

In this manner, as another example, promotional information can be sent to a person watching television, which can be provided without commercial interruption if desired. During the broadcast, acoustic triggers can be sent which provide information about products displayed during the broadcast. The client's device processes the trigger as described above and the resulting alphanumeric string is sent to the server which can then, based on the client's profile, send a promotional offer back to the client's mobile device for possible subsequent redemption. Since the promotional offer can relate to the broadcasted content and be targeted based on the client's profile, the value to the both client and the advertiser is enhanced over the traditional approach of advertising during the broadcast via a commercial interruption which may not even be seen by the client who may leave the room during the commercial or otherwise skip past the commercial interruption if, for example, the broadcasted program is recorded using a DVR.

The specifics of the techniques utilized to implement the specified functionality on a mobile device and server as specified herein are provided by way of example only. Although the use of different frequencies to represent alphanumeric characters is well known, the present invention is directed to the novel use of acoustic triggers representing character strings for a specific purpose as described and claimed herein.

I claim:

1. A method for providing product or service related information to a client comprising:
a) receiving an acoustic signal from a broadcast source, said acoustic signal encoded with product or service related information;
b) translating the received acoustic signal to an alphanumeric string;
c) sending the alphanumeric string and client specific information to a server which is configured to identify product or service information which corresponds to said alphanumeric string using said client specific information;
d) receiving from said server said identified product or service information;
e) storing said received product or service information for subsequent use by said client.
f) the method defined by claim 1.a said acoustic trigger can be replaced by other transports protocol.
g) said transports protocol can be and are not limited to:
BluetoothLE data association
network push notification

2. The method defined by claim 1 wherein said receiving said acoustic signal, said receiving from said server and said storing is by a mobile device.

3. The method defined by claim 2 further comprising:
configuring said mobile device to provide said stored product or service information to a terminal to enable said client to initiate a purchase of said product or service.

4. The method defined by claim 1 wherein said broadcast source is one of a television, radio, movie theater and public address system.

5. The method defined by claim 1 wherein said product or service information includes digital currency.

6. The method defined by claim 2 wherein said mobile device sends said received acoustic signal to a second mobile device configured to receive said acoustic signal and to perform said translating, sending, receiving from said server and storing.

7. A system comprising:
a mobile device configured to
a) receive a acoustic signal from a broadcast source, said acoustic signal encoded with product or service related information
b) translate the received acoustic signal to an alphanumeric string;
c) send the alphanumeric string and client specific information to a server which is configured to identify product or service information which corresponds to said alphanumeric string using said client specific information;
d) receive from said server said identified product or service information;
e) store said received product or service information for subsequent use by an client of said mobile device.

8. The system defined by claim 7 wherein said mobile device is further configured to provide said stored product or service information to a terminal to enable said client to initiate a purchase of said product or service.

9. The system defined by claim 7 wherein said broadcast source is one of a television, radio, movie theater and public address system.

10. The method defined by claim 7 wherein said product or service information includes digital currency.

11. The method defined by claim 7 wherein said mobile device sends said received acoustic signal to a second mobile device configured to receive said acoustic signal and perform said translating, sending, receiving from said server and storing.
